(19) United States
(12) Patent Application Publication
(10) Pub. No.: US 2017/0197392 A1
(43) Pub. Date: Jul. 13, 2017

(54) Fire Retarding Compositions

(71) Applicant: President and Fellows of Harvard College, Cambridge, MA (US)

(72) Inventors: Widusha Illeperuma, Cambridge, MA (US); Zhigang Suo, Lexington, MA (US); Joost J. Vlassak, Lexington, MA (US)

(21) Appl. No.: 15/324,201

(22) PCT Filed: Jul. 6, 2015
(86) PCT No.: PCT/US2015/039237

§ 371 Date: Jan. 5, 2017

Related U.S. Application Data
(60) Provisional application No. 62/021,412, filed on Jul. 7, 2014.

(51) Int. Cl. B32B 27/12; A47G 9/02; A62B 17/00; B65D 85/18; B32B 5/02; A41D 31/00

(52) U.S. Cl. CPC B32B 27/12; B32B 5/022; B32B 5/024; A41D 31/0027; A62B 17/003; B65D 85/18; A47G 9/0207; B32B 2262/0269; B32B 2262/08; B32B 2307/302; B32B 2307/304; B32B 2307/3065; B32B 2571/00; B32B 2437/00

(57) ABSTRACT

A product for use in fire protection includes a laminate including a first layer of insulation and a second layer of hydrogel includes a first network of covalent crosslinks and a second network of ionic or physical crosslinks.

### CROSS REFERENCE TO RELATED APPLICATION

This application claims priority under 35 U.S.C. §119(e) to U.S. Provisional Patent Application No. 62/021,412 filed Jul. 7, 2014, the entire contents of which is hereby expressly incorporated by reference herein in its entirety.

### STATEMENT AS TO FEDERALLY SPONSORED RESEARCH

This invention was made with government support under MRSEC: DMR-0820484 awarded by the National Science Foundation. The government has certain rights in the invention.

### TECHNICAL FIELD

The invention relates to fire protection.

### BACKGROUND

Millions of people worldwide suffer burn injuries and die from such burn-related injuries. Most of the burns are due to residential fires, vehicle crash fires, scalding liquids and hot objects, and contact with electricity. In tight spaces such as skyscrapers, boats, and airplanes, the ability to escape during a fire is compromised, resulting in increased fire risk. The availability of affordable fire retarding apparel such as blankets that can last longer at higher temperatures can make a profound difference in saving lives. A number of drawbacks are associated with existing polymer fabrics, e.g., lack of availability due to high cost as well as poor performance when flame temperatures rise above fabric decomposition temperatures. For example, fire fighters wearing the best fire-retarding materials have only few seconds to evacuate a flashover fire, which can reach temperatures beyond 600° C.

### SUMMARY

The invention provides a solution to many of the drawbacks associated with existing polymer fabrics used in fire protection. The compositions described herein are less expensive to make, can be stored sealed in a hydrated state for long periods of time or can be stored in a dehydrated state for deployment upon hydration. For example, the hydrogels are stored in tightly sealed containers in a hydrated state for at least 1 day (e.g., at least 1, 2, 3, 4, 5, 6, 7 days, or 1, 2, 3, 4, 5 weeks, or 1, 2, 3, 4, 5, 6, 7, 8, 9, 10, 11, 12 months, or 1, 2, 3, 4, 5, 6, 7, 8, 9, 10 years, or more). In other examples, the hydrogels are stored in a dehydrated state. Dehydrated hydrogels are lighter in weight compared to hydrated hydrogels, e.g., of the same surface area or volume. As such, dehydrated hydrogels can be stored in places such as boats or planes, and in case of a fire, they can be contacted, e.g., soaked in water, and then used. For non-porous, e.g., non-macroporous, hydrogels, the rehydration process in some cases takes a longer time compared to porous gels due to slow water diffusion. In some examples, the hydrogels of the invention are porous, e.g., macropores, and thus allow faster water diffusion and faster rehydration.

Accordingly, a product for use in fire protection comprises a laminate comprising a first layer of insulation and a second layer of hydrogel comprising a first network of covalent crosslinks and a second network of ionic or physical crosslinks. The first layer of insulation has a thermal conductivity that is lower than the second layer of hydrogel. For example, the first layer of insulation has a thermal conductivity that is less than about 0.15 W/mk, e.g., the first layer of insulation has a thermal conductivity that is less than about 0.04 W/mk.

The product is characterized by a ratio of a thickness of the second layer of hydrogel to a total thickness of the laminate is between about 0.2 and about 0.8. For example, the ratio of the thickness of the second layer of hydrogel to the total thickness of the laminate is between about 0.6 and about 0.8, e.g., a total thickness of the laminate is about 9 millimeters. In some embodiments, the second layer is greater than 5 millimeters in thickness. And in some examples, the first layer of insulation is threaded through the second layer of hydrogel.

Hydrogel thicknesses are chosen or tailored for various applications or uses. For example, blankets are typically made using sheets that are thicker than those used to construct jackets. For example, blankets have a thickness of about 9-12 mm, and jackets or other apparel have a thickness of about 6-9 mm. Because of their toughness, the flexible hydrogels are resistant to cuts, e.g., more resistant than brittle hydrogels. For example, hydrogels are sewn to join the hydrogel sheet to a fabric, e.g., woven cloth, when creating laminates, similar to the threading of clothes. Alternatively, hydrogels are glued with fabric to create laminates.

The first layer of insulation is an animal-derived, e.g., sheep, goat, muskoxen, or camelid, fabric, such as wool; an aramid, such as NOMEX®; or an oxidized polyacrylonitrile-containing material, such as CarbonX®. Alternatively, the first layer comprises a fabric that has a low thermal conductivity that does not degrade at 100° C. The fabric is characterized by a low thermal conductivity. For example, the lower the thermal conductivity of the fabric, the higher its performance.

The superior performance of the compositions described above are useful for the manufacture of articles that protect humans as well as other animals, companion animals (e.g., dogs and cats), performance animals (e.g., race horses, dogs). For example, an article of clothing comprises a first layer of insulation and a second layer of hydrogel. The second layer comprises a first network of covalent crosslinks and a second network of ionic or physical crosslinks. In some examples, the second layer of hydrogel is on an exterior side of the first layer of insulation. Alternatively, the layers are reversed.

An example of a fire protective item includes an item of clothing (shirt, jacket, trousers, hat, socks, gloves, scarves, shorts, masks, or a blanket, covering for personal/commercial property such as a house, commercial structure, farming structure or, e.g., large sheets of hydrogels are used to cover structures and/or vegetation. For example, the item is an article of clothing where the first layer of insulation has a thermal conductivity that is lower than the second layer of hydrogel. As described above, the first layer of insulation has a thermal conductivity that is less than about 0.15 W/mk e.g., less than about 0.04 W/mk, and the ratio of a thickness of the second layer of hydrogel to a total thickness of the laminate is between about 0.2 and about 0.8, e.g., the ratio of the thickness of the second layer of hydrogel to the total thickness of the laminate is between about 0.6 and about 0.8, e.g., a total thickness of the laminate is about 9 millimeters as well as other features described above.

The compositions are also useful for conservation of land, such as crop-producing acreage or conservation land comprising rare or endangered species such as those threatened by fire. Sprayable slurry-type hydrogels are currently available in the market. However, in some cases, once sprayed, it is difficult to remove the slurry. In contrast, the invention provides a large tough hydrogel sheet that is removable and that can cover land/crops/structures. The compositions are also useful to protect an architectural structure, e.g., dwellings, for fire damage. For example, structures are covered with hydrogel sheets. Hydrogel sheets are stored, e.g., in a dehydrated state. Upon a fire warning, the dehydrated sheets are re-hydrated and used to cover the structures/vegetation. Alternatively, when building structures in fire-prone areas, the exterior walls, roof, doors, etc., can be made with hydrogel-coated materials.

Also within the invention is a method of reducing or preventing a burn to skin of a mammal or an inanimate object by contacting the skin or the object with any one of the laminates or fire-retarding articles (e.g., clothing, sheets, or blankets described herein). A burn is damage or injury caused by exposure to heat or flame. A burn can also be caused by electricity, chemicals, friction, or radiation. The laminates or articles reduce such damage or injury by at least 10%, 20%, 50%, 75%, 2-fold, 5-fold, 10-fold or more compared to the state of the skin/flesh or object in the absence of the fire-retarding. For example, the laminates and/or articles completely prevent such damage/injury.

Other features and advantages of the invention will be apparent from the following description of the preferred embodiments thereof, and from the claims. Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below.

### BRIEF DESCRIPTION OF THE DRAWINGS

FIG. 1a is a diagram and FIGS. 1b-e are photographs showing heat resistivity of different fire-retarding materials. (a) Samples were placed on a hotplate at temperatures Tₕ=350° C. and 500° C. and the top surfaces were observed after 30 seconds. (b) Wool carbonized at 350° C. and became brittle and stiff compared to initial state. At 500° C. it melted on top of the hotplate and cannot be recovered. (c) NOMEX® fabric resisted heat efficiently at 350° C. But at 500° C. it shrank rapidly, it carbonized and turned into a stiff piece of fabric. (d) CarbonX® fabric resisted heat efficiently at both temperatures and did not shrink. (e) Hydrogel did not shrink at high temperature and only few parts of the bottom of the hydrogel carbonized but most parts remained undamaged and flexible.

FIGS. 2a-d are photographs showing thermal images of different fire retarding materials. Shown are time-lapse infrared thermal images of (a) wool, (b), NOMEX®, (c) CarbonX® and (d) hydrogel on top of a hot plate at 500° C. All of the samples were 3 mm thick, 55 mm in length and 37.5 mm in width.

FIGS. 3a-d are photographs, and FIG. 3e is a line graph, each of which shows fire resistivity of different fire-retarding materials. A blowtorch with a flame temperature ˜1000° C. was used to perform the tests. (a) Wool burned through within few seconds when exposed to the flame and turned brittle after the test. (b) NOMEX® fabric burned and shrank rapidly when exposed to flame and became brittle. (c) CarbonX® fabric did not burn through for a very long time. It remained similar to initial fabric when observed after 1 min (d) Hydrogel survived for a long time without burning through. It remained flexible even after 1 min of high flame exposure. (e) Time to burn through is reported with fabric thickness.

FIGS. 4a-b are photographs showing observations made during a flame test. (a) For the hydrogel facing the flame, water starts to evaporate and the dry polymer carbonizes during the flame test. (b) Back surface of the hydrogel remains similar to the initial state where it is still soft and flexible.

FIGS. 5a-c are diagrams showing mechanisms of fire retardation to protect skin. (a) Fire retarding polymer fabrics protect skin mainly due to high decomposition temperature and low thermal conductivity. But under high heat flux they decompose rapidly which causes the skin to burn. (b) For hydrogels, heat from flame is carried away due to evaporation. The other side of the hydrogel can reach 100° C. after some time. (c) In hydrogel-fabric laminates, hydrogel layer carries the heat away and keeps the temperature of the hydrogel-fabric interface at 100° C. until all the water is evaporated while the low thermal conductivity of the fabric protects the skin.

FIGS. 6a-c are photographs showing the burning process of a hydrogel, and FIG. 6d is a schematic showing the mechanism of the burn process. (a) 15 mm thick and 30 mm diameter hydrogel sample is placed on a hotplate with 500° C. temperature. Tiny cavities are formed inside the hydrogel near the bottom surface. A schematic is drawn to understand what is happening inside the hydrogel. It seems polymer network suppresses water coming out but due to phase transition at 100° C. steam comes out by forming small cavities. Tiny bubbles form inside the hydrogel, which collapse eventually. When water is evaporated a dry polymer region form at the bottom and this creates a moving boundary between dry polymer and un-burnt hydrogel. The dry polymer tends to char eventually. (b) The tiny cavities are combined together to form bigger cavities and when they collapse, dry polymer region grows at the expense of un-burnt hydrogel layer. Eventually dry polymer starts to carbonize. (c) With time the hydrogel becomes thinner as the water evaporates and charring layer grows.

FIG. 7a is a diagram and FIG. 7b is a photograph of a Thermal Protective Performance (TPP) test; FIG. 7c is a line graph showing results of the TPP test. (a) TPP test set up. (b) Photo of a hydrogel-fabric laminate. A sheet of hydrogel is threaded with fabric to prepare laminates. (c) Experimental data for heat absorbed by different fire retarding materials are compared with the model data.

FIG. 8a is a diagram, and FIGS. 8b-d are line graphs. (a) System to measure the performance of hydrogel-fabric laminates. (b) Heat output from hydrogel-NOMEX® laminates for different t_{gel}/t values are compared with the Stoll curve. Total thickness used is t=9 mm (c) Heat output from hydrogel-wool laminates for different t_{gel}/t values are compared with Stoll curve. Total thickness used is t=9 mm (d) The surviving times are obtained from the intersection points of Stoll curve and heat output of laminates. Dash line denotes the time to evaporate all the water in hydrogels for different thicknesses.

### DETAILED DESCRIPTION

There is a pressing demand for improved fire retarding materials, which can survive in high temperature flames for extended periods of time while protecting skin from burn injuries and structures. Even though there are many commercially available fire-retarding polymer fabrics, still many burn injuries and burn deaths occur worldwide. Current fire-retarding polymer fabrics are expensive and decompose rapidly at high temperature flames or become very hot, e.g., reach temperatures injurious to human skin. Inexpensive fire-retarding materials were developed using hydrogels, containing about 90% water. These products confer more protection from burn injuries compared to existing products. Even though the protection from hydrogels is better than that of fabrics, the temperature can rise up to 100° C. after some time due to high thermal conductivity of water but remain at 100° C. until all the water is evaporated. Laminates described herein combine hydrogels with fabrics that have low thermal conductivity. In the laminate, a hydrogel layer faces the flame and keeps the temperature at 100° C. for extended periods of time while the fabric with low thermal conductivity protects the skin from burn injuries. These laminates are not effective if conventional weak and brittle hydrogels are used. A tough hydrogel with superior properties was used to prepare the laminates. As these hydrogels contain mostly water, the laminates are much cheaper to make compared to existing fire-retarding fabrics. The laminates described herein have excellent heat and fire retarding properties and are useful in potential lifesaving applications such as fire-retarding blankets or apparel.

### Burn Protection and Fire-Resistant Compositions

Severity of burns depends on the burn temperature and time of contact. If normal blood temperature of human tissue is raised from 36.5° C. to 44° C., skin begins to burn. At 72° C. the top layer of the skin, epidermis is destroyed immediately. Small changes in time of exposure and skin temperature can lead to serious burn injuries.

A common method to protect skin from fire is to use fire-retarding polymer fabrics. Numerous fire-fighting apparels made from polymer fabrics including fire blankets, suits, pants, jackets, gloves are used to protect people when fighting a fire. Fire retarding polymers can be synthesized in two ways. One way is to incorporate flame resistant additives into polymers, which is a relatively cheaper and easy way to synthesize fire-retarding polymers. Another method is to synthesize intrinsically fire resistant polymers which is a more expensive method but more efficient than additive polymers. Chemically modified fabrics with additives include flame retardant cotton, wool etc. Intrinsically fire-resisting fibers include aramid, modacrylic, polybenzimidazole, phenolic, asbestos, ceramic etc. Asbestos has many desirable thermal properties and is cheap but the fibers are very fine and can be breathed into the lungs and promote cancer growth. Glass fibers are also heat resistant but can cause skin irritation. Ceramic fibers can withstand very high temperatures but have poor abrasion resistance, poor aesthetic characteristics, and high densities and are difficult to process. Thus asbestos, glass fibers and ceramic fibers are not widely used in preparing fire-retarding apparel.

Aromatic polyamides known as aramids have been used to make fire-retarding apparels. NOMEX® is the brand name of a flame resistant aramid fiber made by DuPont chemical company. It has become a component in protective apparel widely used by fire fighters. NOMEX® is also used in apparel worn by military pilots, combat vehicle crews, racecar drivers etc. When exposed to intense heat NOMEX® fibers carbonize and thicken which creates a protective barrier between heat source and wearer's skin. NOMEX® is a poor heat conductor thus it takes time for heat to travel through NOMEX®. Aramids are resistant to temperatures around 250° C. for many hours but they begin to char at about 400° C., e.g., within a few seconds. At high temperature flames such as flashover fires, they provide protection only for few seconds. Fire retarding fabrics made from materials including NOMEX®, Kevlar®, and wool are also used as blankets to extinguish small fires. These products are helpful in temperatures up to ˜400° C. but they do not always provide protection of the level desired, particularly when exposed to substantial temperatures or flames.

For example, another material suitable for use as a laminate backing is described in U.S. Pat. No. 6,358,608, incorporated herein by reference. For example, the material comprises an oxidized polyacrylonitrile and one or more additional fibers, which, e.g., are stronger but less fire retardant. Exemplary additional fibers (also called strengthening fibers) include, but are not limited to, polybenzimidazole (PBI), polyphenylene-2,6-benzobisoxazole (PBO), modacrilic, p-aramid, m-aramid, polyvinyl halides, wool, fire resistant polyesters, fire resistant nylons, fire resistant rayons, cotton, and melamine.

To make the material, in some examples, the oxidized polyacrylonitrile fibers and the strengthening fibers are each first carded into respective strands or carded together to form a blended strand. Multiple strands are then intertwined together to form a yarn. Alternatively, strands made from polyacrylonitrile and strengthening fibers, blended strands, or a combination thereof are felted or otherwise formed into a nonwoven mat or sheet.

For example, laminate backing materials include oxidized polyacrylonitrile fibers in an amount in a range from about 85.5% to about 99.9% by weight of the fibers in a yarn, felt, or other fibrous blend. For example, the strengthening fibers that are blended with the oxidized polyacrylonitrile fibers are included in an amount in a range from about 0.1% to about 14.5% by weight of the fibers in the yarn, felt, or other fibrous blend.

In some embodiments, the oxidized polyacrylonitrile fibers are obtained by heating polyacrylonitrile fibers in a cooking process between about 180° C. to about 300° C. for at least about 120 minutes. Examples of suitable oxidized polyacrylonitrile fibers include LASTAN, manufactured by Ashia Chemical in Japan, PYROMEX, manufactured by Toho Rayon in Japan, PANOX, manufactured by SGL, and PYRON, manufactured by Zoltek.

As used herein, the term “yarn” refers to a blend of individual strands of fibers that have been formed by, e.g., “carding” one or more types of “staple fibers”. Carding is a mechanical process that disentangles, cleans, and intermixes fibers to produce a continuous web or sliver suitable for subsequent processing. Most yarns comprise two or more individual threads or strands that have been twisted, spun or otherwise joined to form a bundle of strands. This allows each strand, such as a strengthening fiber strand, to impart its unique properties along the entire length of the yarn. The individual strands within the yarn may be formed from a single type of staple fiber, or they may comprise a blend of two or more different types of staple fibers.

The term “fabric” refers to one or more different types of yarns that have been woven, knitted, or otherwise assembled into a desired protective layer.

The tem. “felt” refers to a more random bundle of strands typically formed by a needle punch process.

The term “fibrous blend” refers to yarns and felts that, e.g., include a mixture of oxidized polyacrylonitrile fibers and at least one strengthening fiber as well as fabrics knitted, woven or otherwise assembled from such yarns. The term “fibrous blend” also refers to individual strands formed by carding a mixture of, e.g., oxidized polyacrylonitrile staple fibers and at least one strengthening staple fiber. The term “fibrous blend” encompasses any fabric that includes yarns, fabrics, felts or strands. See, e.g., U.S. Pat. No. 6,358,608, incorporated herein by reference.

In one embodiment, the laminate backing composing an oxidized polyacrylonitrile and one or more additional fibers comprises CarbonX®. A widely used fire retarding fabric is CarbonX® made from 0-PAN (oxidized polyacrylonitrile) fibers. It has a very high flame resistivity and does not shrink at high temperatures. CarbonX® fabric resists burning when exposed to heat or flames exceeding 1500° C. because the oxidized polyacrylonitrile fibers carbonize and expand, which eliminates any oxygen content within the fabric. Even though CarbonX® fabric is highly flame resistant and demonstrates high thermal protection performance compared with other fire retardant fabrics, its recorded survival time under high heat/flames is still not adequate for many situations requiring protection from fire or injurious/damaging levels of heat. Thus, fire-retarding materials that can provide higher survival times are still much needed.

In firefighting industry, water is one of the best tools to extinguish fires. When water is sprayed, it coats the fuel and creates a barrier, which in turn, prevents oxygen from reaching the fire. Fire has to put a lot of heat energy to boil water, which slows down the fire. But the disadvantage is when water is sprayed on a fire, only a percentage is effective and the rest evaporates or drips down. Hydrogel slurries have been used as fire retarding materials. Hydrogels have a hydrophilic polymer network swollen in water. They are advantageous compared to water as the sticky hydrogels can stay on the applied surface without dripping off. As hydrogels contain mostly water, they have very high heat capacity and high heat of evaporation. Hydrogel slurries have been used in commercial products. In stunt protection, thick layers of hydrogel slurries are applied to protect from extreme heat for a short period of time. Hydrogel slurries are sprayed on to structures to protect burning from wildfire. For the fire to get in to the building, it has to evaporate all the water first thus protect the houses. Hydrogels are also used in burn protection to draw the heat out of a burn. As most of the conventional hydrogels are brittle and weak, they cannot stand by themselves. Thus, these hydrogels are impregnated to different fabrics to make heat-resisting blankets. But as hydrogels can rise up to 100° C. due to high thermal conductivity of water, they do not provide good protection for skin for a long period of time.

Two fire-retarding compositions were used to prepare hydrogel-fabric laminates, which can provide surprisingly better protection compared to individual materials. Conventional hydrogels are weak and brittle thus cannot be used in making laminates. A tough hydrogel that contains a high level of water is a better solution for apparel. Hydrogel-fabric laminates have many advantages compared to hydrogel infused fabrics. For fabrics that are infused with hydrogels, the amount of hydrogel slurry it can absorb is limited. But tough hydrogels are self-supporting, flexible and the thickness is tuned or altered according to the requirement. A hybrid hydrogel containing Polyacrylamide (PAAm) and alginate, which has a record high toughness value was developed [J.-Y. Sun, X. H. Zhao, W. R. K. Illeperuma, O. Chaudhuri, K. H. Oh, D. J. Mooney, J. J. Vlassak, Z. Suo, Highly stretchable and tough hydrogels, Nature, 489, 2012, 133-136]. As it can survive any damage due to high toughness and contains ˜90% water, laminates using this tough hydrogel perform better as a fire retarding material compared to the available materials.

The performance of hydrogels and hydrogel-fabric laminates for protecting skin was evaluated by testing the heat resistivity and fire resistivity of the commercially available fire retarding fabrics and tough PAAm-alginate hydrogels. A heat transfer model was developed to quantify the heat absorbed by the skin when protected with hydrogels and hydrogel-fabric laminates. A standard test known as thermal protective performance (TPP) test was used to measure the performance of different fire retarding materials, and the experimental data was used to calibrate the heat transfer model. A method was developed to measure the performance of fire-retarding fabrics, and the heat transfer model was used to optimize the layer thickness of the laminates for different insulating fabrics to obtain the maximum surviving time under a flashover fire.

### Hydrogel Synthesis:

Polyacrylamide (PAAm)-alginate hybrid hydrogels were prepared using the following procedure: Powders of alginate (FMC Biopolymer, LF 20/40) and acrylamide (Sigma, A8887) were dissolved in deionized water Ammonium persulfate (AP; Sigma, A9164), 0.0017 the weight of acrylamide, was added as the photo initiator for polyacrylamide. N,N-methylenebisacrylamide (MBAA; Sigma, M7279), 0.0006 the weight of acrylamide, was added as the crosslinker for polyacrylamide. N,N,N′,N′-tetramethylethylenediamine (TEMED; Sigma, T7024), 0.0025 the weight of acrylamide, was added as the crosslinking accelerator for polyacrylamide. Calcium sulfate (CaSO₄.2H₂O; Sigma, 31221), 0.1328 the weight of alginate, was added as the ionic crosslinker for alginate. Alternatively, a divalent cation, such as Mg²⁺, Sr²⁺, Ba²⁺, or Be²⁺, or a trivalent cation, such as Al³⁺ or Fe³⁺, is used to crosslink the hydrogels. The solution was poured into a glass mold, 75.0×55.0×6.0 mm³, covered with a glass plate. The gel solution was cured at room temperature by exposing them for eight minutes to ultraviolet light (OAI LS 30 UV flood exposure system, 350 W power with a wavelength of 350 nm). The samples were kept at room temperature for one day to ensure complete reaction. In order to prepare hydrogel-fabric laminates, hydrogels are threaded with NOMEX® aramid strips (McMaster, 8796K56), fire retarding wool (Keane fire and safety equipment company, Inc.), and CarbonX® fabric (CX-6080, Concord Companies, Inc.).

### Heat Resistivity Test:

In order to test the heat resistivity, a hot plate (Dataplate Digital hotplate 720 series) was used at two temperatures; Tₕ=350° C. and 500° C. Samples with dimensions 55 mm*37.5 mm*3 mm were placed on the hot plate for 30 seconds and the top surfaces were observed. Wool, NOMEX®, CarbonX®, and hydrogels were compared for heat resistivity.

### Flame Resistivity Test:

A blowtorch (Home depot, Bernzomatic TS3000KC Self Igniting Torch Kit) with a high temperature flame ˜1000° C. was used to test the flame resistivity. The distance between the blowtorch tip and samples were kept at 6 cm. Wool, NOMEX®, CarbonX®, and hydrogel sample with length 75 mm, width 55 mm and different thicknesses were tested. Tests were conducted until the flame burns through the samples. Burned fabrics were observed after the test.

### Thermal Protective Performance (TPP) Test:

A hotplate (Thermolyne Cimarec 2) with a constant heat flux (1130 W) was used to measure the performance of different fire retarding materials. Heat flux of the hotplate was measured using a power meter (P3 International Kill A Watt EZ Electricity Usage Monitor, P4460). 3 mm thick wool, NOMEX® Carbon X®, hydrogel and laminates with 3 mm hydrogel-3 mm wool and 3 mm hydrogel-3 mm NOMEX®, and 3 mm hydrogel-3 mm CarbonX® were tested. All the samples tested had an area of 18 cm*18 cm similar to the area of the hotplate. A sample was placed on top of the hotplate which was immediately covered by 18 cm*18 cm*2 cm insulating board which has a Copper calorimeter attached to the surface facing the fire-retarding material. Copper calorimeter is a disc with 4 cm diameter and 1.5 mm thickness and two thermocouples (McMaster, Fluke thermocouple thermometer, 40255K32) were attached to the rear side of the calorimeter facing the insulating board. Temperature rise of the Copper disc was recorded as a function of time.

### Heat Resistivity

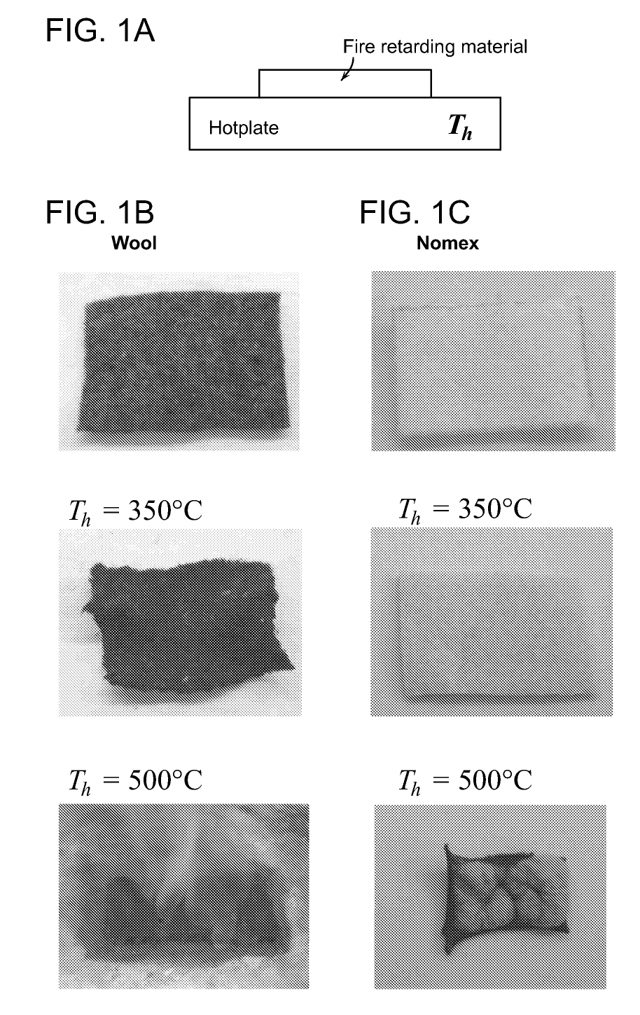

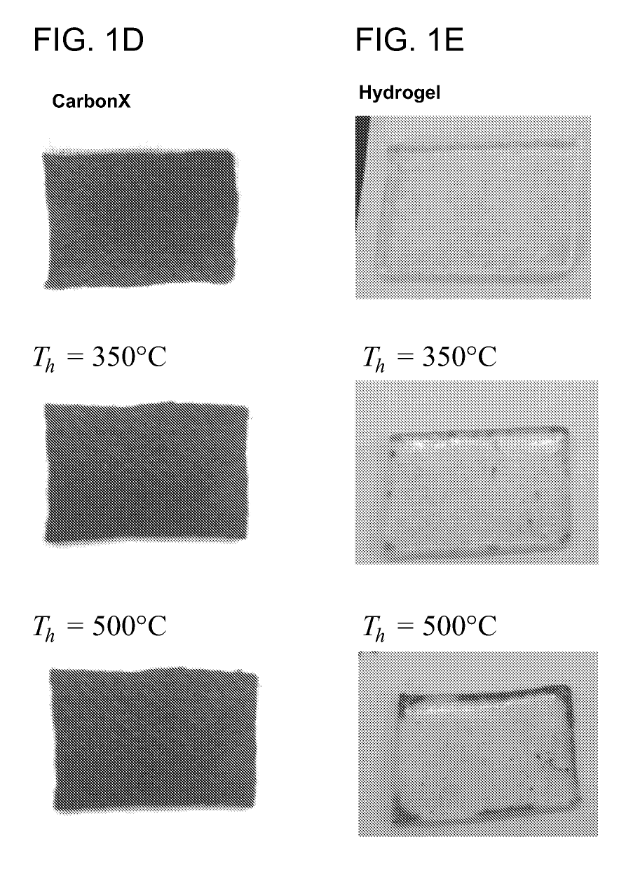

Heat resistivity was tested when fire-retarding materials are placed on a hotplate for 30 seconds at temperatures Tₕ=350° C. and 500° C. as shown in FIG. 1(a). Three commercially available fire retarding fabrics: fire-retarding wool, NOMEX®, and CarbonX® are compared with hydrogel. At 350° C., wool started to carbonize and became very brittle compared to soft fabric at initial state as in FIG. 1(b). At 500° C. it melted on top of the hot plate and cannot be recovered. NOMEX® fabric resisted heat at 350° C. and still remained similar to the initial state according to FIG. 1(c). But at 500° C., it started carbonizing and shrinking. NOMEX® fabric made from aramid fibers begins charring ˜400° C. [A. R. Horrocks, S. Anand, Handbook of technical textiles, CRC Press, 2000]. Even though it did not melt at high temperature, it shrank rapidly and became very stiff and brittle. CarbonX® resisted heat at both 350° C. and 500° C. as shown in FIG. 1(d) and only a slight change in color is observed at the rear side of the fabric.

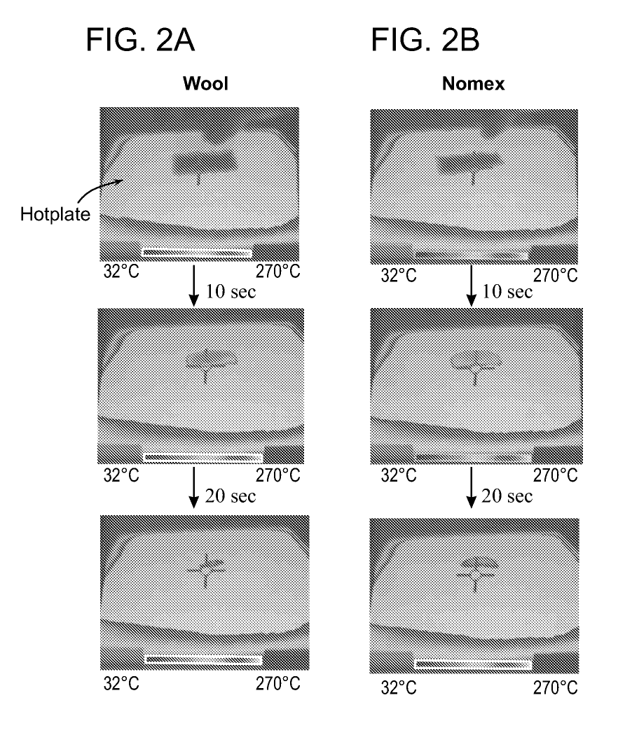

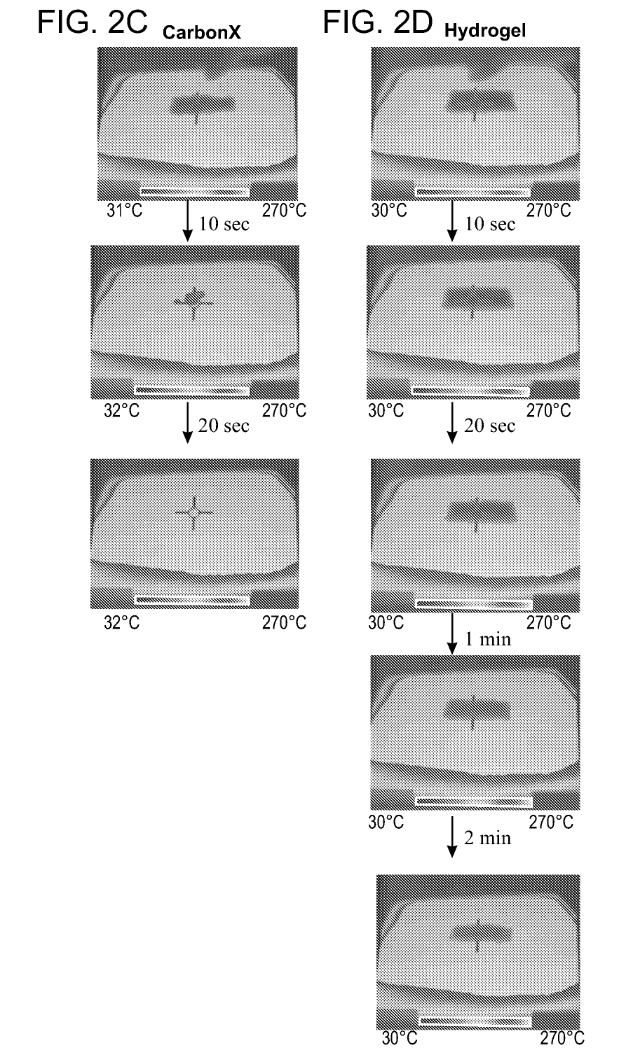

FIG. 1(e) shows that except for few parts, the hydrogel remained similar to the initial state still soft and flexible compared to NOMEX® and wool. These data indicate that both CarbonX® and hydrogel survive very high temperatures ˜500° C. without damaging the samples. In order to observe the temperature of the top surface of samples during hot plate test at 500° C., infrared thermal imaging (FLIR thermal camera) was performed as shown in FIG. 2. Wool, NOMEX® and CarbonX® heated up very rapidly, but hydrogel remained at a low temperature for a long period of time. Even though CarbonX® fabric at high temperature looked similar to the initial state (FIG. 1(d)), the temperature of the CarbonX® fabric rose to very high level. When compared with existing fire retarding fabrics, hydrogels provide better protection at high temperatures. Excellent heat resistivity is attributed to high heat capacity and high heat of evaporation of water inside the hydrogel.

### Fire Resistivity

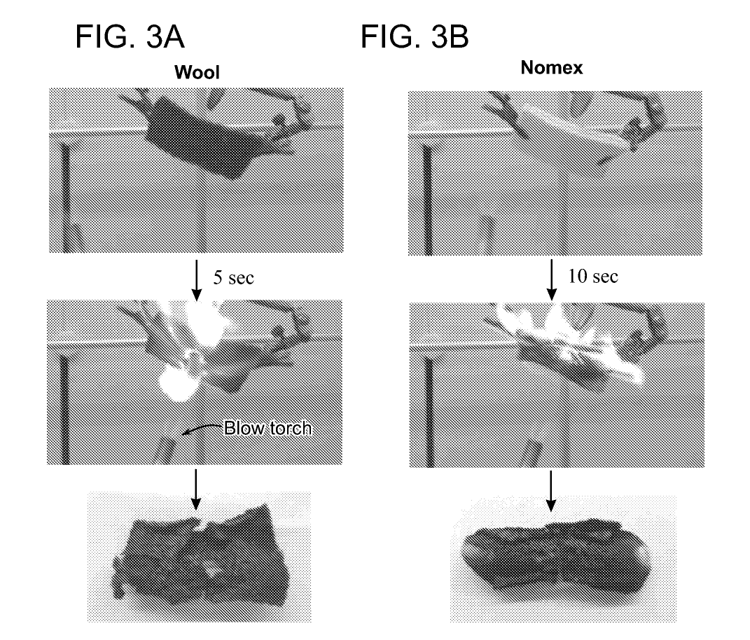

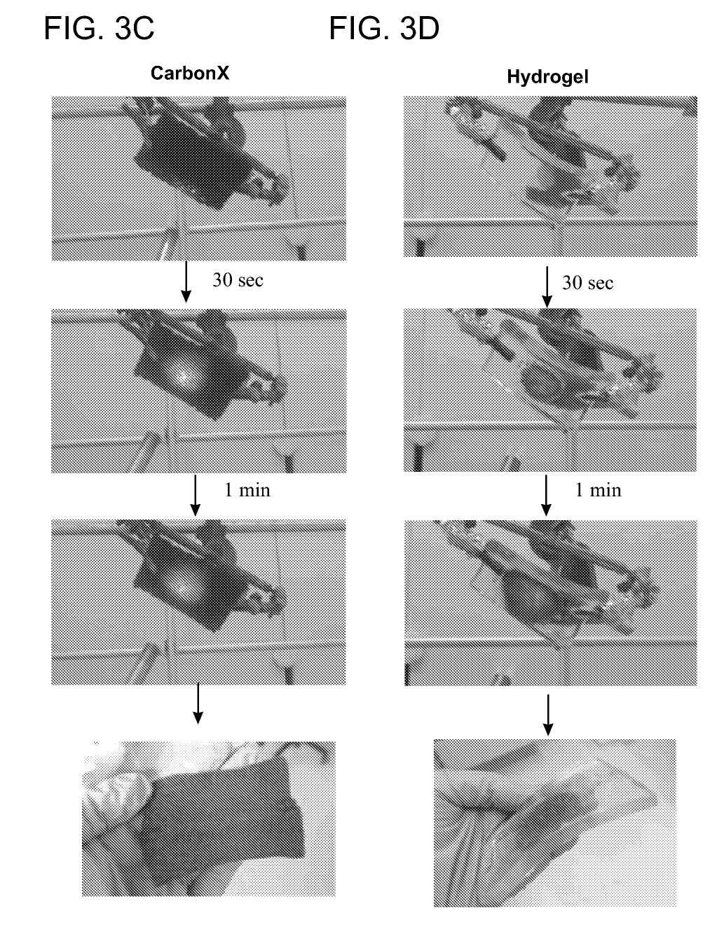

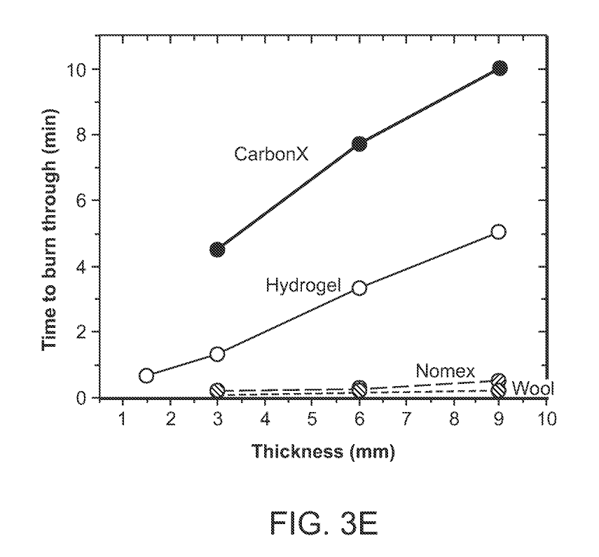

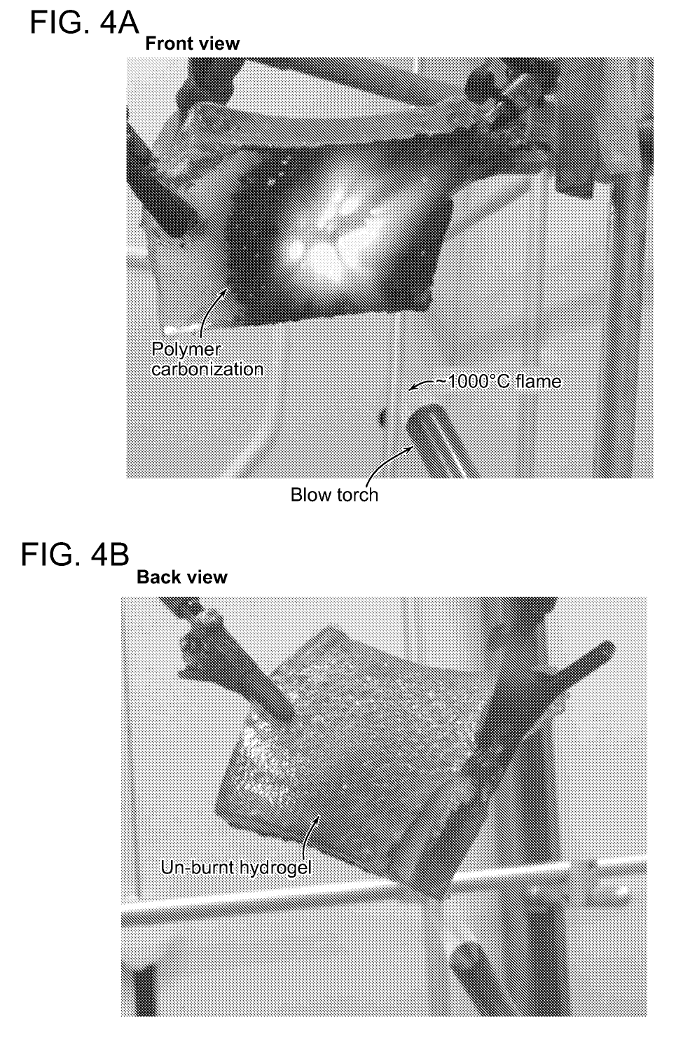

Fire resistivity of wool, CarbonX®, and NOMEX® fabrics were compared with hydrogels under a high temperature flame. Wool and NOMEX® fabrics burned within few seconds when exposed to flames of 1000° C. temperature as shown in FIGS. 3(a) and 3(b). But CarbonX® and tough hydrogels withstood the high temperature flame for a long period of time before burning through as shown in FIGS. 3(c) and 3(d). Photos are shown for samples with 6 mm thickness. Front and rear views of the hydrogel when burning were observed as shown in FIGS. 4a-b. Un-burned rear views show that hydrogel survive extreme high temperature flame for a long period of time without burning through. Images were taken just after the flammability test as shown in FIGS. 3(a)-(d)). Wool and NOMEX® became very stiff and brittle within few seconds but CarbonX® remained similar to its initial state when compared after 1 min. Tough hydrogels when observed even after 1 min, still had lot of un-burned hydrogel in it. Even though the part subjected to high temperature became carbonized, it was only a thin layer and the rest of the hydrogel still remained same, i.e., in a hydrated state and flexible as shown in FIGS. 3d and 4b. When exposed to a flame, water in the hydrogel facing the flame starts to evaporate and a thin dry polymer layer is created. The thickness of the dry polymer layer increases with time until all of the water in the hydrogel is evaporated. The thickness of the dry polymer layer depends on the flame temperature and time of exposure to the flame. The thickness effect is plotted in FIG. 3e. Wool and NOMEX® were found to have a small improvement in the flame resistivity with increased thickness, but CarbonX® and hydrogel enhanced the flame resistivity dramatically. Even though CarbonX® has a better fire resistivity than hydrogel, it heats up rapidly compared to hydrogel and thus does provide as much protection to a wearer when compared to hydrogel.

As the tough hydrogel withstood such a high temperature, these data indicate that it can withstand a flashover fire, which can go up to 600° C. In contrast, most of the currently available fabrics decompose or heat up rapidly under such conditions. The laminate constructs described herein improve and extend the use and performance of such existing fabrics.

### Fire Retarding Mechanisms to Protect Skin

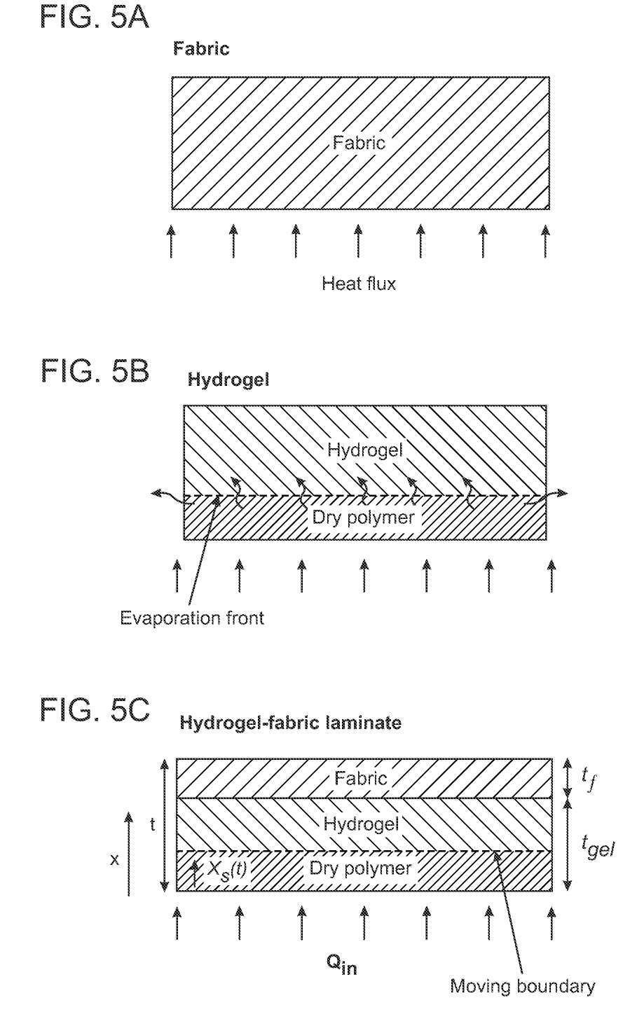

Three different fire-retarding mechanisms to protect skin are discussed as follows. Fire-retarding polymer fabrics usually have high decomposition temperature and low thermal conductivity. Many fire-retarding fabrics retard fire due to formation of protective coating or char to insulate the fabric from the heat source [H. Zhang, Fire-safe Polymers and polymer Composites, Ph.D. Dissertation, University of Massachusetts, 2003]. As shown in FIG. 5(a), when a heat flux is exposed to a fire-retarding polymer fabric it retards fire due to bather formation or other mechanisms [H. Zhang, Fire-safe Polymers and polymer Composites, Ph.D. Dissertation, University of Massachusetts, 2003] and low thermal conductivity of the fabric does not carry the flame heat towards your skin thus protects the skin. But when the temperatures go much higher than its decomposition temperature, as the fabric does not carry the heat away due to low thermal conductivity, the surface facing the flame can be very hot allowing it to decompose rapidly. From heat resistivity test and fire resistivity tests it was observed that both wool and NOMEX® fabric decompose rapidly when exposed to high heat and high temperature flame (FIGS. 1b-c and 3a-b). Thus at temperatures above polymer decomposition, these fabrics cannot provide enough protection for skin. Even though CarbonX® fabric resisted heat and flame (FIGS. 1(d) and 3(c)) due to expansion of fibers and reducing oxygen content in fabric, it cannot provide much protection to skin as the temperature becomes too high (FIG. 2(c)).

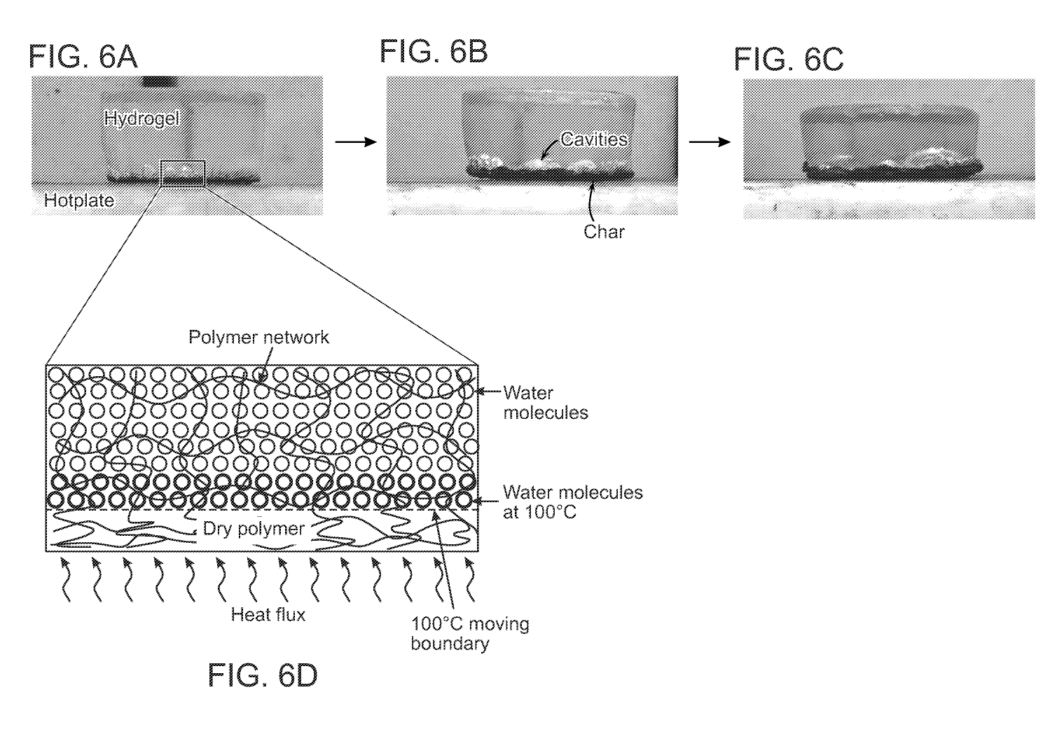

Another method for fire protection is to use hydrogels. Hydrogels contain mostly water, and water has high specific heat capacity (4187 J/kgK) and high heat of evaporation (2.26*10⁶ J/kg). When the heat flux is exposed, part of heat from flame is carried away due to evaporation of water as shown FIG. 5(b). When water is evaporated it generates two layers; dry polymer layer where all the water is evaporated and the hydrogel layer which still has water. The two regions are separated by a moving boundary corresponding to a temperature of 100° C. This behavior is observed using a thick hydrogel as shown in FIG. 6. Due to the high thermal conductivity of water (˜0.58 W/mK), the other side facing skin can reach 100° C. after some time and remain at that temperature for a longer period of time until all of the water is evaporated.

Laminating hydrogels with low thermal conductive fabrics make better fire-retarding materials compared to hydrogels and fabrics as individual materials. Both materials participate in providing better performance. As shown in FIG. 5(c) hydrogel layer carries the heat away and keeps the temperature of the hydrogel-fabric interface at 100° C. until all the water is evaporated. Even though how high the flame temperature is, the maximum temperature observed by the fabric facing hydrogel is 100° C. for a long period of time. By selecting a fabric with low thermal conductivity that has the ability to survive a temperature of 100° C., skin can be protected for a long period of time, e.g., the side of the fabric facing skin remains at a safe temperature level for skin.

The burn protection from hydrogel and hydrogel-fabric laminates is tested using the following models.

### Heat Transfer

The procedure used to model the heat transfer through hydrogels and hydrogel-fabric laminates is described below. The evaporation process in the protective layer is approximated as a one dimensional heat transfer problem with a moving phase boundary, which is solved with an enthalpy method [J. Crank, Free and Moving Boundary Problems (2nd ed) Oxford University Press, New York (1975)]. Similar enthalpy models are used for materials made with cement mortar and polymer gels with a moving boundary [Z. F. Jin, Y. Asako, Y. Yamaguchi Y and M. Harada, Fire resistance test for fire protection materials with high water content, Int J Heat Mass Transfer, 2000, 43, 4395-4404; Y. Asako, T. Otaka, Y. Yamaguchi, Fire Resistance Characteristics of Materials with Polymer Gels Which Absorb Aqueous Solution of Calcium Chloride, Numer. Heat Transfer, Part A, 2004, 45, 49-66]. Any flow of water or steam inside of the material was neglected. FIG. 5(c) shows the hydrogel-fabric laminate with thickness t in its reference state. It consists of one layer of hydrogel of thickness t_{gel} and one layer of fabric of thickness t_{f}. The hydrogel consists of a polymer network with density ρₚ and heat capacitance cₚ and water with density ρ_{w} and heat capacitance c_{w}. The heat of evaporation of water at its boiling temperature T_{b} is h_{f}. The concentration of polymer by weight is wₚ. The insulating fabric has a density ρ_{f} and a heat capacitance c_{f}. When heat is added at the bottom of the hydrogel, it heats up until water starts to evaporate. The zone in which phase transition takes place is modeled as an infinitely thin boundary at boiling temperature, which travels through the hydrogel as shown in FIG. 5(c). The boundary at x=xₛ(t) divides the hydrogel in two regions. The material in region I (x>xₛ(t)) the temperature consists of the original hydrogel at temperatures below the boiling temperatures. In region II (x<xₛ(t)) the water is evaporated and the remaining polymer network is at a temperature above the boiling temperature. While the boundary moves through the hydrogel, the whole sample becomes thinner due to drying of the hydrogel. The layer of insulating fabric constrains the deformation of the hydrogel such that it dries under plane strain condition.

In both regions, Fourier's law

$$q = - {k}_{i} \frac{\partial T}{\partial x} \qquad ( 1 )$$

is valid, where q is the heat flux per area, T is the temperature, and kᵢ has to be replaced by the heat conductivities k_{I} and k_{II} in the corresponding regions. Energy balance in both regions requires

$$\frac{\partial h}{\partial t} + v \frac{\partial h}{\partial x} = {k}_{i} \frac{{\partial }^{2} T}{{\partial }^{2} x} , \qquad ( 2 )$$

where h is the enthalpy of the material and v the speed at which the material moves due to drying of the hydrogel. The enthalpy of the hydrogel can be described as

$$\begin{matrix}T < {T}_{b} \text{:} & h = \frac{{c}_{w} / {c}_{p} + {w}_{p} ( 1 - {c}_{w} / {c}_{p} )}{{ρ}_{p} / {ρ}_{w} + {w}_{p} ( 1 - {ρ}_{p} / {ρ}_{w} )} {ρ}_{p} {c}_{p} ( T - {T}_{b} ) \\ T = {T}_{b} \text{:} & 0 < h < \frac{{c}_{w} / {c}_{p} + {w}_{p} ( 1 - {c}_{w} / {c}_{p} )}{{ρ}_{p} / {ρ}_{w} + {w}_{p} ( 1 - {ρ}_{p} / {ρ}_{w} )} {ρ}_{p} {h}_{f} \\ T > {T}_{b} \text{:} & h = {ρ}_{p} {c}_{p} ( T - {T}_{b} )\end{matrix} . \qquad ( 3 )$$

By defining

$$\begin{matrix}{c}_{I} = \frac{{c}_{w} / {c}_{p} + {w}_{p} ( 1 - {c}_{w} / {c}_{p} )}{{ρ}_{p} / {ρ}_{w} + {w}_{p} ( 1 - {ρ}_{p} / {ρ}_{w} )} {c}_{p} & ( 4 ) \\ {\tilde{h}}_{f} = \frac{{c}_{w} / {c}_{p} + {w}_{p} ( 1 - {c}_{w} / {c}_{p} )}{{ρ}_{p} / {ρ}_{w} + {w}_{p} ( 1 - {ρ}_{p} / {ρ}_{w} )} {h}_{f} & ( 5 )\end{matrix}$$

the expression for h can be simplified to

T<T_{b}:h=c_{I}ρₚ(T−T_{b})

T=T_{b}:0<h<\tilde{h}_{f}ρₚ

T>T_{b}:h=\tilde{h}_{f}ρₚcₚρₚ(T−T_{b}) (6)

To simplify the mathematical analysis, all quantities are expressed in a material coordinate. X describes the location of a material point with respect to the original swollen hydrogel. In this coordinate system, the phase boundary is at a location

$${X}_{s} ( t ) = \frac{{x}_{s} ( t )}{λ} . \qquad ( 7 )$$

The stretch λ is the ratio of the thicknesses of the dry gel and the swollen gel. Under plane strain, condition λ can be determined to be

$$λ = \frac{{w}_{p}}{{ρ}_{p} / {ρ}_{w} + {w}_{p} ( 1 - {ρ}_{p} / {ρ}_{w} )} . \qquad ( 8 )$$

Thus the energy balance becomes

$$X > {X}_{s} ( t ) \text{:} \frac{\partial H}{\partial t} = {k}_{I} \frac{{\partial }^{2} T}{{\partial }^{2} X} \\ X < {X}_{s} ( t ) \text{:} \frac{\partial H}{\partial t} = \frac{{k}_{II}}{λ} \frac{{\partial }^{2} {T}^{′}}{{\partial }^{2} X} \qquad ( 10 )$$

where H=h/λ is the enthalpy of the material in the material coordinate system. By introducing the transformation \hat{T}=T−T_{b} in region I and \hat{T}=(T−T_{b})k_{II}/(k_{I}λ) both equations combine in (10) to

$$\frac{\partial H}{\partial t} = {k}_{I} \frac{{\partial }^{2} \hat{T}}{{\partial }^{2} X} . \qquad ( 11 )$$

Equation (6) is rewritten to

\hat{T}<0:H=c_{I}ρₚ\hat{T}

\hat{T}=0:0<H<\tilde{h}_{f}ρₚ

\hat{T}>0:H=\tilde{h}_{f}ρₚ+λ²cₚρₚk_{I}/k_{II}(T−T_{b}) (12)

The heat transfer in the insulating fabric is modelled with

$${ρ}_{f} {c}_{f} \frac{\partial T}{\partial t} = {k}_{f} \frac{{\partial }^{2} T}{{\partial }^{2} x} , \qquad ( 13 )$$

where k_{f} is the thermal conductivity of the fabric.

Equations (11) and (13) are integrated over time with an explicit Euler algorithm and use a central difference scheme to approximate the special derivatives [J. Crank, Free and Moving Boundary Problems (2nd ed) Oxford University Press, New York (1975)]. After each integration step equation (12) is used to update the temperature at each node [J. Crank, Free and Moving Boundary Problems (2nd ed) Oxford University Press, New York (1975)]. The heat transfer model is calibrated with a standard test, and it is used to predict the performance of hydrogel and hydrogel-fabric laminates.

### Thermal Protective Performance (TPP) Test

TPP test is a standard test to measure the performance of fire retarding materials according to the NFPA (National Fire Protection Association) 1971 test standards [http://www.nfpa.org/]. This test has been widely used to measure the thermal protection for fire-retarding fabrics [W. P. Behnke, Thermal protective performance test for clothing, Fire Technol, 1977, 1,6-12; W. P. Behnke, Predicting flash fire protection of clothing from laboratory tests using second-degree burn to rate performance, Fire and Materials, 1984, 8:2, 57-63]. TPP test measures the fabric's ability to block the heat, which can cause second-degree burns when exposed to 2 cal/cm²s heat flux. This heat flux is chosen to replicate a flashover fire. The standard test involves exposing a combination of radiant and convective heat flux to the fabric and a Copper calorimeter placed above the specimen records the heat transferred through the specimen. The heat/time curve obtained in this test is compared with human tissue tolerance to heat to get a TPP rating [W. P. Behnke, Thermal protective performance test for clothing, Fire Technol, 1977, 1,6-12; W. P. Behnke, Predicting flash fire protection of clothing from laboratory tests using second-degree burn to rate performance, Fire and Materials, 1984, 8:2, 57-63].

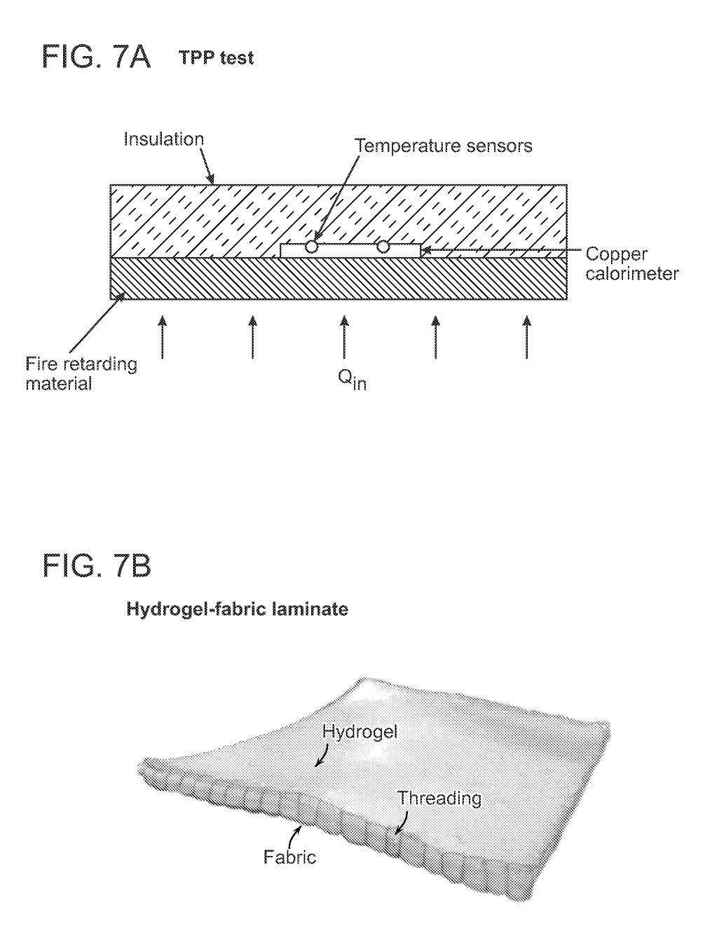

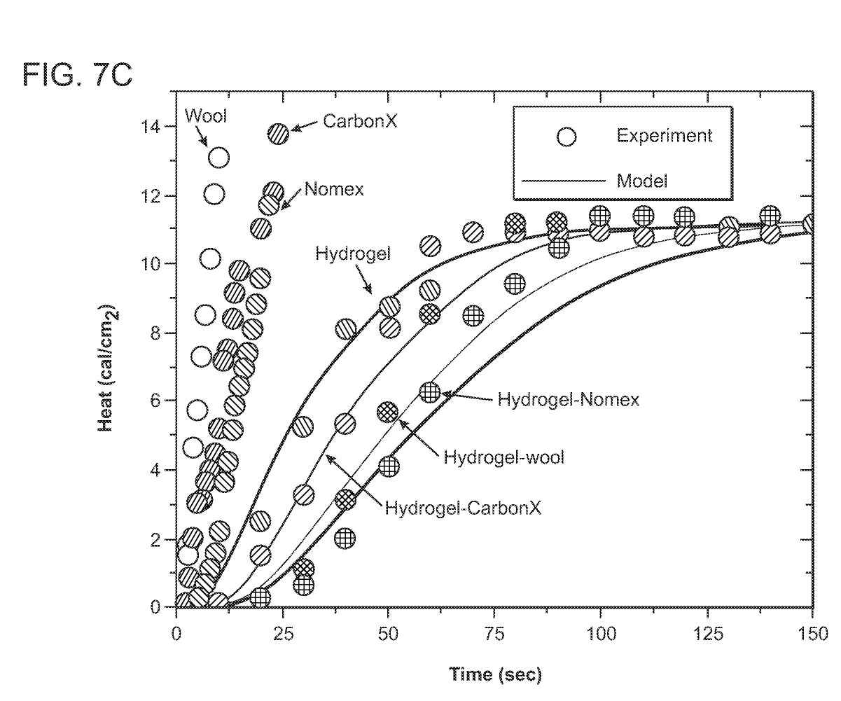

The TPP test was modified as follows. The purpose of performing this test is to compare different fire-retarding materials and to calibrate our heat transfer model. A reduced heat flux (0.8 cal/cm²s) compared to the standard test is used due to the limitation of the maximum heat flux of the available hotplate. The test set up is shown in FIG. 7(a) where a hotplate was used to apply the heat flux. Total heat absorbed by the calorimeter is obtained by the temperature change in copper calorimeter multiplied by mass and specific heat of the copper calorimeter. The hydrogel-fabric laminates are prepared according to FIG. 7(b) by threading hydrogel and fabric together. As the hydrogel described herein is very tough, it can survive threading similar to a fabric, an important and advantageous attribute compared to conventional weak and brittle hydrogels. Total heat absorbed by the calorimeter is plotted for different materials as shown in FIG. 7(c). Heat absorbed by 3 mm thick NOMEX®, CarbonX®, and wool rise up faster. Even at this heat flux, they do not provide enough protection as the temperature of the hot plate (500° C.) is above the fabric decomposition temperature. A 3 mm hydrogel has better protection compared to the fabrics but as the thermal conductivity of water is high, it also can heat up faster. Hydrogel-fabric laminates are prepared using 3 mm thick hydrogels and 3 mm thick fabrics. The laminates show better performance compared to their parent materials. The heat transfer model was used to obtain heat/time curves for hydrogel and laminates. The following properties for fabrics are used in the model. For NOMEX®, specific heat is used as 1748 J/kgK, thermal conductivity 0.15 W/mK and density 446 kg/m³. For wool, specific heat is used as about 1200 J/kgK, thermal conductivity 0.04 W/mK and density 162 kg/m³. For CarbonX®, specific heat is used as 1200 J/kgK, thermal conductivity 0.04 W/mK and density is used as 75 kg/m³. Agreement between the experimental data and the model was observed. At low heat level data, the most relevant heat level as human tissue cannot absorb more than 4-5 cal/cm²s heat during this time period without second-degree burns.

### Optimizing Parameters

Hydrogel-fabric laminates have better performance compared to parent materials (FIG. 7(c)). The thickness of hydrogel and fabric layers can be altered and therefore optimized to tailor performance. The heat transfer model is used to optimize the thickness for hydrogel-wool and hydrogel-NOMEX® laminates.

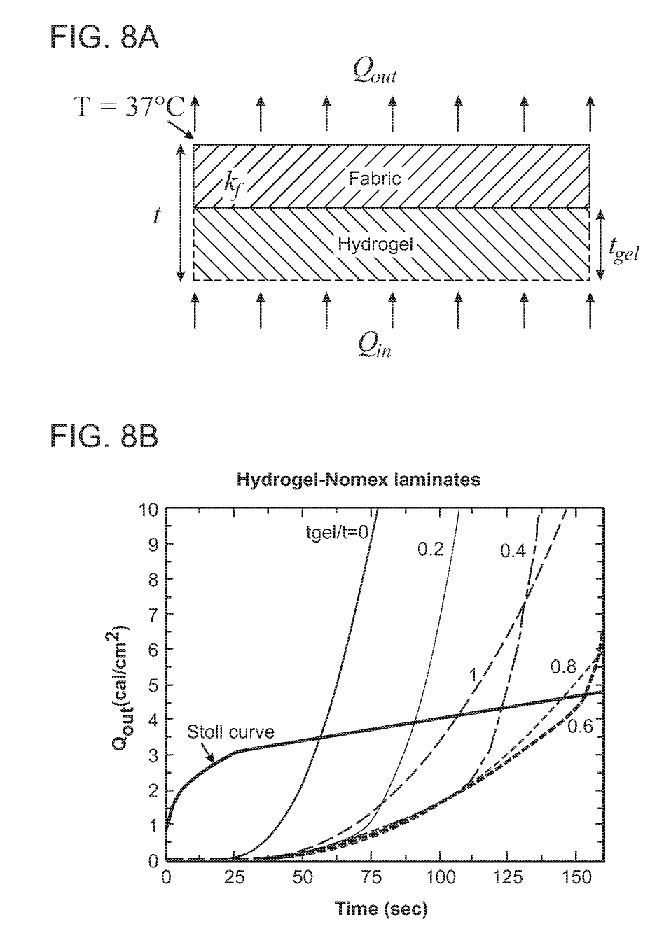

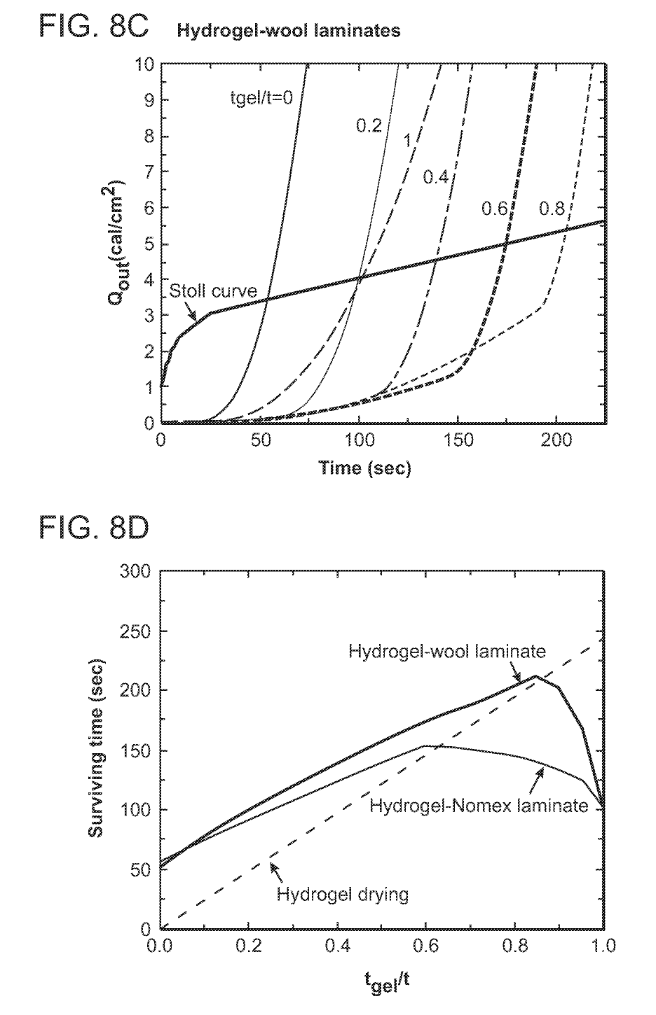

Even though the TPP test is a standard test used to measure the performance of fire retarding fabrics, it has drawbacks. It is reported that firefighter's suits, which reported 17.5 seconds surviving time from TPP test, can only survive around 10 seconds in a real scenario. TPP is a test designed to measure the performance during a short duration and does not produce detailed information to evaluate thermal performance of protective clothing over a range of conditions. Thus, the performance measured by TPP test has been questioned in the literature [W. E. Mell, J. R. Lawson, A heat transfer model for fire fighters' protective clothing, Fire technology, 2000, 36, 39-68; J. F. Krasny, J. A. Rockett, D. Huang, Protecting fire fighters exposed in room fires: comparison of results of bench scale test for thermal protection and conditions during room flashover, Fire technology, 1988, 24, 5-19]. In the TPP test, the insulating layer blocks the heat flux output from the fabric, which is different from the real scenario. As the heat flux is blocked, the effectiveness of the laminates does not show during this test. Thus, the test method was modified to measure the surviving time of fire-retarding fabrics. Instead of blocking the heat flux, skin temperature (37° C.) is imposed at the top surface of fabric that faces the skin and the heat output from the fabric is measured. The initial temperature of the setup is assumed to be 37° C. A heat flux of Qᵢₙ=2 cal/cm²s is used as the flame heat input to mimic the flashover fire and the heat output from the fabric that can go to the skin is calculated. The setup is shown in FIG. 8(a). t_{gel}/t is the thickness ratio of hydrogel to the total sample thickness. Thermal conductivity of the fabric is denoted as k_{f}. Heat output of the fabric, Qₒᵤₜ or in other words heat that will be absorbed by the skin is calculated for both hydrogel-NOMEX® and hydrogel-wool laminates as shown in FIGS. 8(b) and (c) corresponding to different t_{gel}/t values. The total thickness used in this analysis is t=9 mm.

Literature data for heat exposures on human skin were used to determine the level of heat energy that would create a second-degree burn [A. M. Stoll and M. A. Chianta, Method and rating system for evaluation of thermal protection, Aerospace Med., 1969, 40, 1232-1238]. The heat flux was varied and the time that creates a second-degree burn was measured. A second-degree burn is where a blister forms and the outer layer of human skin; the epidermis is destroyed. The heat flux vs time curve was integrated to get the total heat absorbed by the skin. This curve is known as the “Stoll curve” and shown in FIGS. 8(b) and 8(c) in black color. This curve sets an important criterion when designing fire-retarding materials to protect skin. As long as the heat passing through the fire retarding fabric is below the heat set by the Stoll curve, the material protects the skin.

Heat output from hydrogel-fabric laminates is compared with the Stoll curve for heat absorbed by skin to avoid second-degree burns. The intersection points give the surviving time and they are plotted in FIG. 8(d). Hydrogel-fabric laminates provided better surviving time compared to fabric and hydrogel itself. Even with pure hydrogel it is possible to maintain 37° C. without second-degree burns for a longer time compared to fabrics. But with laminates better surviving time were observed.

Hydrogel-wool laminates have better protection compared to hydrogel-NOMEX® laminates due to the low thermal conductivity of wool compared to NOMEX®. According to the model, the lower the thermal conductivity of the fabric, the better the performance is. Thus, if a fabric which has thermal conductivity lower than wool is used, an even better surviving time is achieved. The dashed line indicates the complete drying of the hydrogel when all the water is evaporated. As soon as hydrogel dries out, it can go beyond 100° C. and when the temperature reaches the decomposition temperature of the fabric, it can protect the skin for only a few seconds. The curves to the left of the intersection of dash line might collapse with the dashed line (FIG. 8d) in a flashover fire scenario, as our model does not include decomposition of fabric. In the laminates, the fabric portion of the construct does not have to be a fire-retarding material, because its purpose is to survive 100° C. temperature and provide thermal insulation to the skin.

Applications for hydrogel-fabric laminates include fire-retarding products such as blankets or apparel. For example, these hydrogels are integrated with suits that are used by fire fighters or other critical applications that require more protection. These products are inexpensive compared to most of the highly engineered fire-retarding polymer fabrics and can be readily available in many places. The hydrogel-fabric laminates can be stored at homes or any other places in case of a fire emergency. For example, a possible scenario is a burning room (e.g., a hotel room, cruise ship, boat, and the like) and an occupant can grab a hydrogel-fabric blanket to wrap around and escape from the building. The tough hydrogels contain about 90% water. Thus, it cannot be stored in open air for a long period of time as the water tends to evaporate. Thus these materials need to be kept sealed to avoid losing its function. In addition, the blankets may be packaged in a single-use form (e.g., disposable after use). Alternately, the products are stored in a dehydrated state and are rehydrated prior to use, e.g., for use of a boat or other situation with easy access to water. Macroporous dehydrated hydrogels can be stored in many places, e.g., places that have access to water, and they can be rehydrated within a few minutes prior to use.

Tough, Fire-Retarding Blankets Made from Hydrogels and Hydrogel-Fabric Laminates

Widely used fire-retarding polymer fabrics protect skin from burn injuries mainly due to high decomposition temperature and low thermal conductivity. Above the decomposition temperatures they do not provide good protection. Hydrogels are also used in fire retarding applications but cannot be used for a long period of time as they reach 100° C. but remain there for a long period of time until all the water is evaporated. By combining the two mechanisms prepared are hydrogel-fabric laminates that are much better than hydrogels and fabrics. The laminates are made by securing the layers together or using other methods such as fusing or sewing the layers or gluing layers together. Hydrogel layer protects from high heat flux and stay at 100° C. for a long time until all the water is evaporated while fabric with low thermal conductivity keeps the skin at a safe temperature.
1. http://www.ameriburn.org/resources_factsheet.php.
2. Zhang, H. Fire-Safe Polymers and Polymer Composites, Federal Aviation Administration technical report; U.S. Department of Transportation: Washington, D.C., 2004.
3. http://www.firetactics.com/FLASHOVER %20-%20FIREFIGHTERS %20NIGHTMARE.pdf.
4. A. M. Stoll and M. A. Chianta, Method and rating system for evaluation of thermal protection, Aerospace Med., 1969, 40, 1232-1238.
5. Connolly, W. J.; Thornton, A. M. Aluminum Hydrate Filler in Polyester Systems. Mod. Plastics 1965, 43 (2), 154-202.
6. H. Zhang, Fire-safe Polymers and polymer Composites, Ph.D. Dissertation, University of Massachusetts, 2003.
7. A. R. Horrocks, S. Anand, Handbook of technical textiles, CRC Press, 2000
8. http://www.dupont.com/products-and-services/personal-protective-equipment/thermal protective/brands/NOMEX®.html.
9. http://www2.dupont.com/Personal_Protection/en_GB/assets/PDF/TI/NOMEX®% C2% AE %20Applications %20for %20Industrial %20Workers.pdf.
10. A. R. Monahan, Thermal degradation of polyacrylonitrile in the temperature range 280-450° c., J. Polym. Sci. A-1 Polym. Chem., 4, 1966, 2391-2399.
11. http://www.zeller-int.com/categories/fireret/zeljel.htm.
12. Bashaw R. N., Freport, Harper B. G., Jackson L., U.S. Pat. No. 3,229,769, 1966.
13. Hicks R. D., Mills J. E., Hsu W.-N., Agne A., U.S. Pat. No. 6,245,252 B1, 2001.
14. Toreki W., U.S. Patent 2007/0001156 A1.
15. Bridgeman W. M., U.S. Pat. No. 6,102,128, 2000.
16. Romaine J. W., U.S. Pat. No. 4,624,320, 1986.
17. J.-Y. Sun, X. H. Zhao, W. R. K. Illeperuma, O. Chaudhuri, K. H. Oh, D. J. Mooney, J. J. Vlassak, Z. Suo, Highly stretchable and tough hydrogels, Nature, 489, 2012, 133-136.
18. http://www.chicagoprotective.com/pdf/CarbonX®.pdf.
19. K. E. Perepelkin, Oxidized (Cyclized) Polyacrylonitrile Fibres—Oxypan: A Review, Fibre Chem 2003, 35: 409-416.
20. J. Crank, Free and Moving Boundary Problems (2nd ed) Oxford University Press, New York (1975).
21. Z. F. Jin, Y. Asako, Y. Yamaguchi Y and M. Harada, Fire resistance test for fire protection materials with high water content, Int J Heat Mass Transfer, 2000, 43, 4395-4404.
22. Y. Asako, T. Otaka, Y. Yamaguchi, Fire Resistance Characteristics of Materials with Polymer Gels Which Absorb Aqueous Solution of Calcium Chloride, Numer. Heat Transfer, Part A, 2004, 45, 49-66.
23. http://www.nfpa.org/.
24. W. P. Behnke, Thermal protective performance test for clothing, Fire Technol, 1977, 1,6-12.
25. W. P. Behnke, Predicting flash fire protection of clothing from laboratory tests using second-degree burn to rate performance, Fire and Materials, 1984, 8:2, 57-63.
27. S. Lee, C. Park, D. Kulkarni, S. Tamanna, T. Knox, Heat and mass transfer in a permeable fabric system under hot air jet impingement, Proceedings of the international heat transfer conference, IHTC14, 2010, 1-10.
28. http://www2.dupont.com/Energy_Solutions/en_US/assets/downloads/418_419.pdf
29. A. Handermann, Oxidized Polyacrylonitile fiber properties, products and applications, Zoltek corporation (http://www.zoltek.com/white-paper-oxidized-polyacrylonitrile-fiber-properties-products-and-applications/).
29. W. E. Mell, J. R. Lawson, A heat transfer model for fire fighters' protective clothing, Fire technology, 2000, 36, 39-68.
30. J. F. Krasny, J. A. Rockett, D. Huang, Protecting fire fighters exposed in room fires: comparison of results of bench scale test for thermal protection and conditions during room flashover, Fire technology, 1988, 24, 5-19.
31. Huang T. J., William J. H., Chapmen M. R., U.S. Pat. No. 6,287,686B1, 2001.

### OTHER EMBODIMENTS

While the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A laminate comprising:
a first layer of insulation; and
a second layer of hydrogel comprising a first network of covalent crosslinks and a second network of ionic or physical crosslinks.

2. The laminate of claim 1, wherein the first layer of insulation has a thermal conductivity that is lower than the second layer of hydrogel.

3. The laminate of claim 1, wherein the first layer of insulation has a thermal conductivity that is less than about 0.15 W/mk.

4. The laminate of claim 1, wherein the first layer of insulation has a thermal conductivity that is less than about 0.04 W/mk.

5. The laminate of claim 1, wherein a ratio of a thickness of the second layer of hydrogel to a total thickness of the laminate is between about 0.2 and about 0.8.

6. The laminate of claim 5, wherein the ratio of the thickness of the second layer of hydrogel to the total thickness of the laminate is between about 0.6 and about 0.8.

7. (canceled)

8. (canceled)

9. (canceled)

10. The laminate of claim 1, wherein the first layer of insulation is threaded through the second layer of hydrogel.

11. An article of clothing comprising:
a first layer of insulation; and
a second layer of hydrogel comprising a first network of covalent crosslinks and a second network of ionic or physical crosslinks, wherein the second layer of hydrogel is on an exterior side of the first layer of insulation.

12. The article of clothing of claim 11, wherein the first layer of insulation has a thermal conductivity that is lower than the second layer of hydrogel.

13. The article of clothing of claim 11, wherein the first layer of insulation has a thermal conductivity that is less than about 0.15 W/mk.

14. The article of clothing of claim 11, wherein the first layer of insulation has a thermal conductivity that is less than about 0.04 W/mk.

15. The article of clothing of claim 11, wherein a ratio of a thickness of the second layer of hydrogel to a total thickness of the laminate is between about 0.2 and about 0.8.

16. The article of clothing of claim 15, wherein the ratio of the thickness of the second layer of hydrogel to the total thickness of the laminate is between about 0.6 and about 0.8.

17. (canceled)

18. (canceled)

19. (canceled)

20. The article of clothing of claim 11, further comprising a hermetically sealed container, for storage of the article of clothing.

21. The article of clothing of claim 11, wherein the article of clothing is a blanket.

22. The laminate of claim 1, wherein the first layer of insulation comprises a wool, an aramid, or an oxidized polyacrylonitrile.

23. A method of reducing or preventing a burn to skin of a mammal or an inanimate object comprising contacting the skin or the object with the laminate of claim 1.

24. The article of claim 11, wherein the first layer of insulation comprises a wool, an aramid, or an oxidized polyacrylonitrile.

25. A method of reducing or preventing a burn to skin of a mammal or an inanimate object comprising contacting the skin or the object with the article of claim 11.
